(19) United States
(12) Patent Application Publication
(10) Pub. No.: US 2018/0140981 A1
(43) Pub. Date: May 24, 2018

(54) EXCHANGE UNIT AND FLOW CIRCUIT SYSTEM USING SAME

(71) Applicant: ROKI TECHNO CO., LTD., Tokyo (JP)

(72) Inventor: Takashi KINJO, Tokyo (JP)

(21) Appl. No.: 15/574,823

(22) PCT Filed: May 19, 2015
(86) PCT No.: PCT/JP2015/002520

§ 371 Date: Nov. 16, 2017

(51) Int. Cl. B01D 35/30; B01D 27/08

(52) U.S. Cl. CPC B01D 35/306; B01D 2201/347; B01D 27/08

(57) ABSTRACT

Provided is an exchange unit to be removably mounted in a predetermined direction between a first pipeline end portion and a second pipeline end portion of a manifold of a flow circuit. The manifold includes the first pipeline end portion having a first opposed surface reduced in a mounting direction and the second pipeline end portion having a second opposed surface reduced in the mounting direction. The exchange unit includes a first flow path end portion having a first complementary surface having a shape complementary to the first opposed surface and a second flow path end portion having a second complementary surface having a shape complementary to the second opposed surface. In this manner, even when a dimensional variation is generated in distance between the first flow path end portion and the second flow path end portion of the exchange unit due to a manufacturing tolerance, the first pipeline end portion and the second pipeline end portion of the manifold and the first flow path end portion and the second flow path end portion of the exchange unit can be brought into close contact with each other under a uniform load.

### TECHNICAL FIELD

The invention of the present application relates to an exchange unit, which includes, for example, a filter built therein, and is removably mounted so as to be replaceable as a part of an existing pipeline to enable formation of the pipeline, and to a flow circuit system using the same.

### BACKGROUND ART

For a pipeline provided for the purpose of filtration of a fluid, an exchange unit, which includes a filter or other members built therein, and is removable so as to be replaceable, is provided as a part of the pipeline. For example, after a predetermined amount of filtration is completed, an old exchange unit is removed to be replaced by a new exchange unit. The pipeline described above lacks a part thereof between an upstream-side end portion of the pipeline and a downstream-side end portion of the pipeline. The exchange unit has a structure which allows removable mounting thereof between the upstream-side end portion of the pipeline and the downstream-side end portion of the pipeline. The exchange unit has a flow path formed inside, and has a flow path inlet and a flow path outlet at both ends of the flow path. The filter or other members is arranged in the flow path. In general, the upstream-side end portion of the pipeline and the downstream-side end portion of the pipeline are constructed as a part of a manifold. When the exchange unit is mounted to the manifold, the flow path inlet of the exchange unit is joined to the upstream-side end portion of the pipeline, whereas the flow path outlet is jointed to the downstream-side end portion of the pipeline. In this manner, the flow path of the exchange unit is coupled to the partially lacking pipeline to complete a pipeline of a flow circuit system.

### CITATION LIST

### Patent Literature

PTL 1: Japanese Patent No. 4723531

PTL 2: Japanese Patent Application Laid-Open No. H3-123689

### SUMMARY OF INVENTION

### Technical Problem

In Patent Literature 1, there is disclosed an example of the exchange unit which is removably mounted so as to be replaceable as a part of an existing pipeline to enable the formation of the pipeline. In Patent Literature 1, a distance between the upstream-side end portion of the pipeline of the manifold and the downstream-side end portion of the pipeline of the manifold is invariable. The exchange unit is mounted between those end portions by a pivoting operation using any one of the flow path inlet and the flow path outlet of the exchange unit as a pivot axis. In the mounting of the exchange unit using the pivoting operation, however, an end on a side opposite to the pivoting axis has a large range of motion. Therefore, a frictional distance of a sealing member is long to increase wear of the sealing member. As a result, there occurs a problem of generation of dust.

Further, in general, in an exchange unit including flow path end portions respectively at both side end portions of a main body portion, there is generated a variation in distance between the flow path end portions of the exchange unit depending on an individual due to a manufacturing tolerance. When the variation is generated in distance between the flow path inlet and the flow path outlet of the exchange unit, the manifold with a distance between the upstream-side end portion of the pipeline and the downstream-side end portion of the pipeline of the manifold being kept invariable by the exchange unit has a problem in that a deviation is generated between a position at which the upstream-side end portion of the pipeline of the manifold and the flow path inlet of the exchange unit are joined to each other and a position at which the downstream-side end portion of the pipeline of the manifold and the flow path outlet of the exchange unit are joined to each other for the amount of the variation. Further, the above-mentioned problem leads to problems such as leakage occurring because of a desired pressing force failing to reach the sealing member and increased wear of the sealing member as a result of application of a load equal to or larger than the desired pressing force onto the sealing member.

Meanwhile, in Patent Literature 2, there is disclosed a water purifier cartridge to be used in a sink. In Patent literature 2, there are disclosed a manifold including a slidable sleeve pipe and the water purifier cartridge. On the manifold side, the distance between the upstream-side end portion of the pipeline and the downstream-side end portion of the pipeline remains unvaried. As the water purifier cartridge disclosed in Patent Literature 2, there is disclosed the water purifier cartridge in which one end of a flow path of the water purifier cartridge is screwed into one end of a pipeline of the manifold and the sleeve pipe of the manifold is extended to be coupled to another end of the pipeline of the manifold. However, the coupling using screwing is complicated for an engineer. At the same time, for a fluid having a high pressure, a form in which the slidable sleeve pipe is simply extended to be coupled to the another end of the pipeline of the manifold cannot be adopted. Further, in an industrial filtering device for which a filtered target is liable to be solidified, when a movable section is provided on the manifold, an adhesive substance contained in the fluid firmly adheres to a movable portion of the movable section, which is disadvantageous.

### Solution to Problem

In order to solve the above-mentioned problems, there is provided an exchange unit to be removably mounted in a predetermined direction between a first pipeline end portion and a second pipeline end portion of a manifold of a flow circuit, the manifold including the first pipeline end portion having a first opposed surface reduced in the mounting direction and the second pipeline end portion having a second opposed surface reduced in the mounting direction, the exchange unit including: a first flow path end portion having a first complementary surface having a shape complementary to the first opposed surface; and a second flow path end portion having a second complementary surface having a shape complementary to the second opposed surface.

### Advantageous Effects of Invention

According to the present invention, the exchange unit without a movable portion, which can be removably mounted only by a translational operation, is achieved.

### BRIEF DESCRIPTION OF DRAWINGS

FIG. 1 is a view for illustrating an exchange unit according to a first embodiment to which the present invention is applied and a part of a flow circuit.

FIG. 2 is a view for illustrating a structure for preventing leakage of a fluid between the exchange unit and a manifold, for one end of the exchange unit to which the present invention is applied.

FIG. 3 is a view for illustrating another structure for preventing the leakage of the fluid between the exchange unit and the manifold, for the one end of the exchange unit to which the present invention is applied.

FIG. 4 is a view for illustrating an end portion of the exchange unit as viewed from a pipeline of the manifold illustrated in FIG. 3.

FIG. 5 is a view for illustrating a state in which a uniform load is generated, for the one end of the exchange unit to which the present invention is applied.

FIG. 6 is a view for illustrating an exchange unit according to a second embodiment to which the present invention is applied and a part of a flow circuit is applied.

FIG. 7 is a view for illustrating an exchange unit according to a third embodiment to which the present invention is applied and a part of a flow circuit.

FIG. 8 is a view for illustrating an example of application of the exchange unit which can be used in the third embodiment.

FIG. 9 is a view for illustrating an example of application when the present invention is applied to the one end of the exchange unit.

### DESCRIPTION OF EMBODIMENTS

### First Embodiment

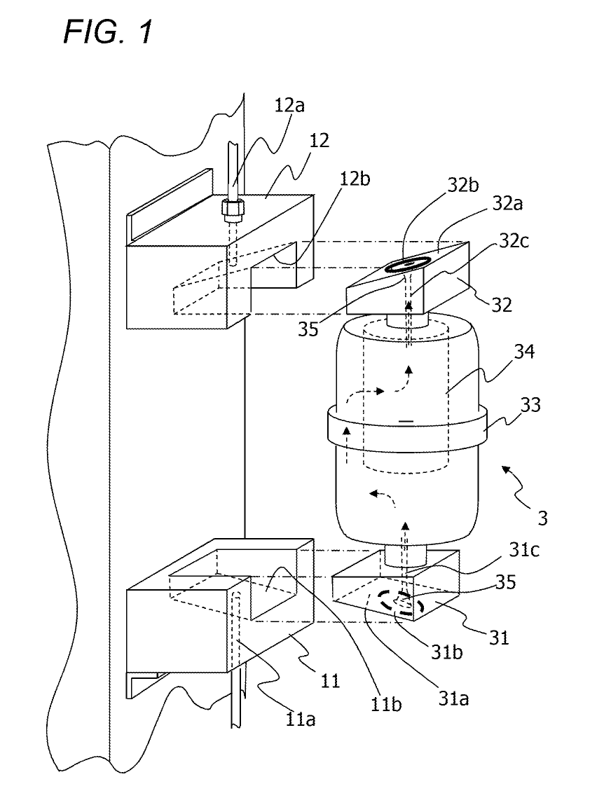

With reference to FIG. 1 to FIG. 5, the invention of the present application is described. FIG. 1 is a diagram for illustrating a manifold 1 as a part of a flow circuit. The manifold 1 includes a first pipeline end portion 11 and a second pipeline end portion 12. The flow circuit in which the manifold 1 is mounted has a flow-path lacking portion between the first pipeline end portion 11 and the second pipeline end portion 12. The first pipeline end portion 11 and the second pipeline end portion 12 are arranged so as to be opposed to each other, and each can be constructed as, for example, a block-like member. For example, a pipeline 11a connected to a fluid source (not shown) is connected to the first pipeline end portion 11 to enable formation of an upstream side of the flow circuit, whereas a pipeline 12a connected to a destination of exhaust of the fluid (not shown) is connected to the second pipeline end portion 12 to enable formation of a downstream side of the flow circuit. However, a relationship between the upstream side and the downstream side of the manifold 1 is merely an example, and can be set oppositely. Hereinafter, the first pipeline end portion 11 side is described as the upstream side, and the second pipeline end portion 12 is described as the downstream side as an example in this specification.

The first pipeline end portion 11 has an opposed surface 11b, and the second pipeline end portion 12 has an opposed surface 12b. The opposed surface 11b and the opposed surface 12b are opposed to each other. The first pipeline end portion 11 and the second pipeline end portion 12 are fixed, and hence a distance between the surface 11b and the surface 12b which are opposed to each other is invariable. The exchange unit 3 is removably mounted so as to be directly fitted over the distance by a translational operation in a lateral direction with respect to a direction from the first pipeline end portion 11 to the second pipeline end portion 12. Here, the “lateral direction with respect to the direction from the first pipeline end portion 11 to the second pipeline end portion 12” is defined as a “mounting direction” when the exchange unit 3 is mounted by the translational operation. The opposed surface 11b of the first pipeline end portion 11 is inclined with respect to the mounting direction. Further, the opposed surface 12b of the second pipeline end portion 12 is also inclined with respect to the mounting direction. A direction of inclination of the opposed surface 11b of the first pipeline end portion 11 and a direction of inclination of the opposed surface 12b of the second pipeline end portion 12 of the manifold 1 are in a mode of reducing in the mounting direction when the exchange unit 3 is mounted by the translational operation.

Specifically, the manifold 1 constructing a part of the flow circuit system according to the present invention is the flow-path lacking portion being a part of the flow circuit. A flow path inside the exchange unit 3 is joined between the first pipeline end portion 11 being one end of the lacking portion and the second pipeline end portion 12 being another end thereof, thereby completing the flow circuit system. At one end of the manifold 1 being the lacking portion of the flow path, when the lateral direction with respect to the direction from the one end to the another end is the mounting direction, the first pipeline end portion 11 being the one end and the second pipeline end portion 12 being the another end respectively include the opposed surface 11b and the opposed surface 12b which are inclined with respect to the mounting direction.

The exchange unit 3 includes a first flow path end portion 31, a second flow path end portion 32, and a main body portion 33. The first flow path end portion 31 extends at one end of the main body portion 33, whereas the second flow path end portion 32 extends to the main body portion 33 on a side opposite to the one end portion. The main body portion 33 has a hollow portion inside, and hence, for example, a filter 34 or other members may be arranged in the hollow portion. The filter 34 or other members is a filter member with an ion-exchange resin, an adsorbent such as zeolite or a diatom earth, a member obtained by combining the adsorbent and the filter member, or the like. As indicated by the broken lines in the exchange unit 3 of FIG. 1, a flow path from the first flow path end portion 31 through the filter 34 or other members to the second flow path end portion 32 is formed inside the exchange unit 3. The exchange unit 3 in the first embodiment is supposed to be assembled to keep a manufacturing tolerance between the first flow path end portion 31 and the second flow path end portion 32 in manufacture. Therefore, because of a large total length, a variation generated between individuals is relatively large in manufacture of the exchange unit 3.

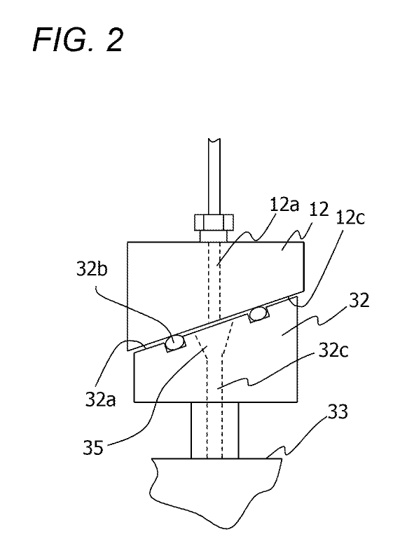

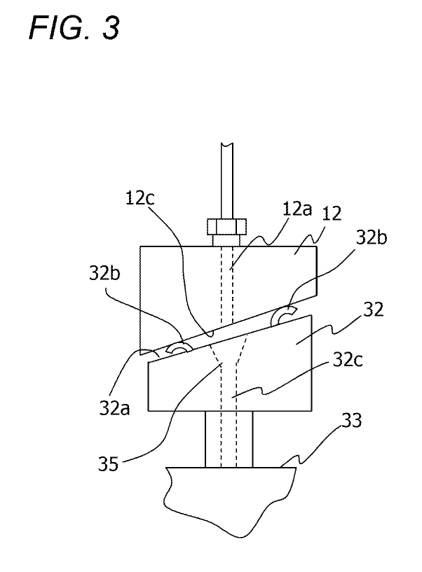

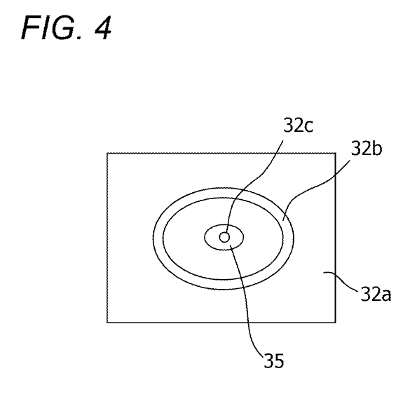

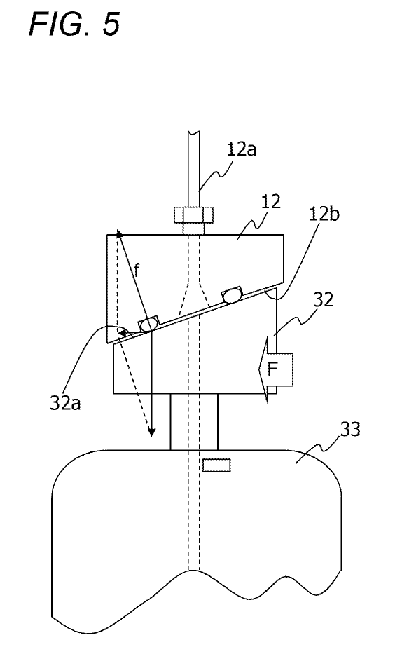

With reference to FIG. 2 to FIG. 4, a connected portion between the end portion of the flow path of the exchange unit 3 and the end portion of the flow path of the manifold is described. FIG. 2 is a view for illustrating the connected portion between the end portion of the flow path of the exchange unit 3 and the end portion of the flow path of the manifold as the most typical example. FIG. 3 is a view for illustrating the connected portion between the end portion of the flow path of the exchange unit 3 and the end portion of the flow path of the manifold in another mode. FIG. 4 is a view for illustrating the flow path end portion of the exchange unit 3 as viewed from the end portion of the flow path of the manifold. FIG. 5 is a view for illustrating the connected portion between the end portion of the flow path of the exchange unit 3 and the end portion of the flow path of the manifold in a mode in which arrangement of a sealing member is changed.

The first flow path end portion 31 of the exchange unit 3 has a complementary surface 31a having a shape which is complementary to the opposed surface 11b of the first pipeline end portion 11 of the manifold 1. Similarly, the second flow path end portion 32 of the exchange unit 3 has a complementary surface 32a having a shape which is complementary to a shape of the opposed surface 12b of the second pipeline end portion 12 of the manifold 1. As a typical example of the complementary shape, when each of the shape of the opposed surface 11b of the first pipeline end portion 11 and the shape of the opposed surface 12b of the second pipeline end portion 12 of the manifold 1 is a plane having an inclination, the complementary surface 31a and the complementary surface 32a are inclined surfaces which are respectively complementary to the planes. The complementary surface means that an angle of inclination at a desired position on the opposed surface 11b and an angle of inclination of the complementary surface 31a at a position corresponding thereto are the same, and similarly, an angle of inclination at a desired position on the opposed surface 12b and an angle of inclination of the complementary surface 32a at a position corresponding thereto are the same. The angle of inclination herein includes an angle of a curve in a tangential direction. Specifically, the term “complementary” includes, when the opposed surfaces 11b and the opposed surface 12b are curved surfaces, the complementary surface 31a and the complementary surface 32a are complementary curved surfaces having the same tangent at corresponding positions respectively thereon. Further, a combination of a curved surface and a plane is similarly included. Further, the “complementary shape” does not mean coupling such as fitting but means, presupposing that a necessary minimum clearance such as a manufacturing tolerance or a surface roughness is uniformly generated between the opposed surface 11b of the first pipeline end portion 11 of the manifold 1 and the complementary surface 31a of the exchange unit 3, boundary surfaces having the same shape.

The most typical relationship between the opposed surface 11b of the first pipeline end portion 11 of the manifold 1 and the complementary surface 31a of the exchange unit 3 is in a mode illustrated in FIG. 1 and FIG. 2 as the first embodiment. Specifically, as illustrated in FIG. 2, in the first embodiment, the opposed surface 12b of the second pipeline end portion 12 of the manifold 1 is an inclined plane having an inclination, whereas the complementary surface 32a having the shape which is complementary to the inclined plane is an inclined plane having an inclination at the same angle as that of the opposed surface 12b. Specifically, the complementary surface 32a has a parallel relationship with the opposed surface 12b. Similarly, the opposed surface 11b of the first pipeline end portion 12 of the manifold 1 is also an inclined plane having an inclination, whereas the complementary surface 31a having a shape which is complementary to the inclined plane is an inclined plane having an inclination at the same angle as that of the opposed surface 11b. Further, in the first embodiment, a direction of inclination of the opposed surface 11b of the first pipeline end portion 11 of the manifold 1 and a direction of inclination of the opposed surface 12b of the second pipeline end portion 12 are directions of inclination about the same axis in the opposite directions and have a relationship of being reduced in the “mounting direction” of the exchange unit 3. Similarly, a direction of inclination of the complementary surface 31a of the first flow path end portion 31 of the exchange unit 3 and a direction of inclination of the complementary surface 32a of the second flow path end portion 32 have a relationship of being reduced in the “mounting direction” of the exchange unit 3. However, the angles of inclination thereof may be the same or may differ from each other.

A sealing member 31b such as an O-ring is provided on the complementary surface 31a of the first flow path end portion 31 of the exchange unit 3, whereas a sealing member 32b such as an O-ring is provided on the complementary surface 32a of the second flow path end portion 32 of the exchange unit 3. The sealing member 31b and the sealing member 32b are respectively pressed against the surfaces opposed thereto to be brought into close contact therewith. In a case of an example of FIG. 2, the sealing member 32b is provided on the complementary surface 32a of the second flow path end portion 32 of the exchange unit 3. The complementary surface 32a of the second flow path end portion 32 is pressed against the opposed surface 12b of the second pipeline end portion 12 of the manifold 1 by a pressing force applied onto the exchange unit 3 to be brought into close contact therewith. Although not illustrated in FIG. 2, the sealing member 31b is similarly set on the complementary surface 31a of the first flow path end portion 31 so as to be brought into close contact therewith by the pressing force applied onto the exchange unit 3. In the example of FIG. 2, the sealing member 31b and the sealing member 32b are provided to the exchange unit 3. However, the sealing member 31b and the sealing member 32b may be provided respectively on the opposed surface 11b and the opposed surface 12b of the manifold 1. Further, although the sealing member 31b and the sealing member 32b are provided as members independent of the exchange unit 3 as represented by the O-rings in FIG. 2, the sealing member 32b may be formed as elastic projections which project toward the opposed surface 12b as a part of the complementary surface 32a of the second flow path end portion 32 of the exchange unit 3, as illustrated in FIG. 3. The sealing member 32 is arranged so as to completely surround a port of a pipeline 32c of the second flow path end portion 32 of the exchange unit 3, as illustrated in FIG. 4. The arrangement on the complementary surface 31a of the first flow path end portion 31 of the exchange unit 3 is similar to that on the complementary surface 32a of the second flow path end portion 32.

As described above, setting the opposed surface 11b of the first pipeline end portion 11 of the manifold 1 and the complementary surface 31a of the first flow path end portion 31 of the exchange unit 3 at the same angle of inclination and parallel to each other is typically a simple way. However, the opposed surface 11b of the first pipeline end portion 11 of the manifold 1 and the complementary surface 31a of the first flow path end portion 31 of the exchange unit 3 are brought into contact with each other through the sealing member 31b therebetween. Therefore, the angle of inclination of the opposed surface 11b and the angle of inclination of the complementary surface 31a are not necessarily required to be the same. For example, as illustrated in FIG. 3, the angles of inclination may be different as long as the sealing member 32b is held in close contact with both the opposed surface 11b and the complementary surface 31a without generating a gap at the sealing member 32b in the entire region surrounding the pipeline 32c on each of the opposed surface 11b of the second pipeline end portion 12 of the manifold 1 and the complementary surface 31a of the first flow path end portion 31 of the exchange unit 3. Further, one of the opposed surface 11b and the complementary surface 31a may be a plane and another thereof may be a curved surface as long as the sealing member 32b is held in close contact with both the opposed surface 11b and the complementary surface 31a without generating a gap at the sealing member 32b.

Further, as illustrated in FIG. 2, the flow path 32c inside the second flow path end portion 32 of the exchange unit 3 has an expanding portion 35 having a funnel-like shape. When the distance between the first flow path end portion 31 and the second flow path end portion 32 differs between individuals due to a variation in manufacturing tolerance, the second flow path end portion 32 of the exchange unit 3 is shifted to the left (far side in the mounting direction of the exchange unit 3) or to the right (near side in the mounting direction of the exchange unit 3) in each of the individuals. However, the flow path 32c has the expanding portion 35. Therefore, even when the flow path 32c inside the second flow path end portion 32 of the exchange unit 3 is shifted to the far side or the near side in the mounting direction with respect to the pipeline 12a of the second pipeline end portion 12 of the manifold 1, the flow path 32c has a structure which enables coupling between the pipeline 12a of the second pipeline end portion 12 of the manifold 1 and the flow path 32c inside the second flow path end portion 32 of the exchange unit 3 through a fluid. Further, the expanding portion 35 of the flow path may be provided not to the exchange unit 3 but to the manifold 1, specifically, to each of the pipeline 11a of the second pipeline end portion 11 and the pipeline 12a of the second pipeline end portion 12. However, the sealing member 32b needs to be provided to any one of the exchange unit 3 and the manifold 1, to which the expanding portion 35 is provided. For example, it is not preferred to provide the expanding portion 35 to the exchange unit 3 and the sealing member 32b to the manifold 1. The same applies to the first flow path end portion 31 of the exchange unit 3.

Further, in FIG. 5, a relationship between the second pipeline end portion 12 of the manifold 1 and the second flow path end portion 32 of the exchange unit 3 is illustrated. When the opposed surface 12b of the second pipeline end portion 12 of the manifold 1 and the complementary surface 32a of the second flow path end portion 32 of the exchange unit 3 have shapes complementary to each other, when a pressing force F is applied in the “mounting direction” for mounting the exchange unit 3 by the translational operation, the complementary surface 32a of the second flow path end portion 32 of the exchange unit 3 presses the opposed surface 12b of the second pipeline end portion 12 with a component force f thereof. Even when a variation occurs in the distance between the first flow path end portion 31 and the second flow path end portion 32 of the exchange unit 3 due to the manufacturing tolerance and hence some exchange units 3 have a short distance and other have a long distance, the pressing force F generates the component force f uniformly at an interface between the complementary surface 32a of the second flow path end portion 32 and the opposed surface 12b of the second pipeline end portion 12 of the manifold 1 as long as the opposed surface 12b of the second pipeline end portion 12 of the manifold 1 and the complementary surface 32a of the second flow path end portion 32 of the exchange unit 3 have complementary shapes. Thus, the sealing member 32b can be brought into close contact with the opposed surface 12b of the second pipeline end portion 12 of the manifold 1 constantly with the same pressing force. Even when the distance between the first flow path end portion 31 and the second flow path end portion 32 is different due to a variation in manufacturing tolerance, the generated component force is theoretically the same as long as the planes have the same angle of inclination. The same applies to the opposed surface 11b of the first pipeline end portion 11 of the manifold 1.

As a pressing unit configured to fix the exchange unit 3 to the manifold 1 while pressing the exchange unit 3 in the mounting direction with the pressing force F, it is conceivable to use, for example, a belt (not shown). Besides, a method of fixing the exchange unit 3 to the manifold 1 while pressing the exchange unit 3 in the mounting direction with the pressing force F can be achieved in various modes.

As long as the first flow path end portion 31 of the exchange unit 3 has the complementary surface 31a having the shape which is complementary to the shape of the opposed surface 11b of the first pipeline end portion 11 of the manifold 1 and the second flow path end portion 32 of the exchange unit 3 has the complementary surface 32a having the shape which is complementary to the opposed surface 12b of the second pipeline end portion 12 of the manifold 1, when the exchange unit 3 is fixed to the manifold 1 with the pressing force F while pressing the exchange unit 3 in the mounting direction by any method, the sealing member 31b and the sealing member 32b can be pressed against the opposed surface 11b of the first pipeline end portion 11 and the opposed surface 12b of the second pipeline end portion 12 of the manifold 1 with the predetermined pressing force, respectively.

In the first embodiment, by the joint between the complementary surface 31a of the first flow path end portion 31 of the exchange unit 3 and the opposed surface 11b of the first pipeline end portion 11 of the manifold 1 and the joint between the complementary surface 32a of the second flow path end portion 32 of the exchange unit 3 and the opposed surface 12b of the second pipeline end portion 12 of the manifold 1, positioning is performed along an axis extending in the direction from the first pipeline end portion 11 to the second pipeline end portion 12 of the manifold 1. Therefore, positioning along an axis in a direction perpendicular thereto cannot be performed. Thus, by matching a width of each of two side surfaces adjacent to the complementary surface 31a of the first flow path end portion 31 of the exchange unit 3 and a width of each of two side surfaces adjacent to the opposed surface 11b of the first pipeline end portion 11 of the manifold 1, the positioning is performed along the direction perpendicular to the direction from the first pipeline end portion 11 to the second pipeline end portion 12 of the manifold 1. Therefore, the positioning along the direction perpendicular to the direction from the first pipeline end portion 11 to the second pipeline end portion 12 of the manifold 1 is achieved by fitting the first flow path end portion 31 of the exchange unit 3 into the first pipeline end portion 11 of the manifold 1.

### Second Embodiment

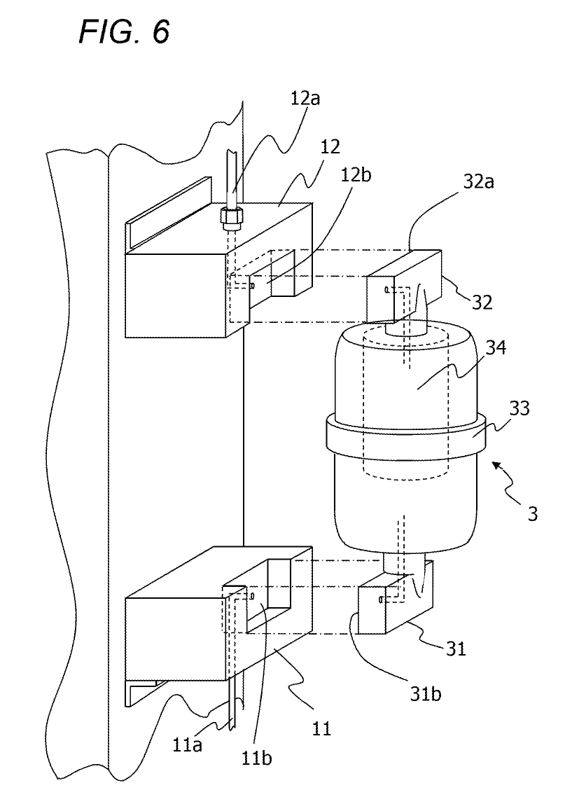

A second embodiment of the present invention as a unique example of the first embodiment is in a mode illustrated in FIG. 6. In FIG. 6, there is illustrated an example where the angle of inclination of the opposed surface 11b of the first pipeline end portion 11 of the manifold 1 is 90 degrees with respect to the mounting direction of the exchange unit 3 and the angle of inclination of the opposed surface 12b of the second pipeline end portion 12 is 90 degrees, which is oriented in a direction opposite to that of the angle of inclination of the opposed surface 11b of the first pipeline end portion 11. Specifically, the opposed surface 11b of the first pipeline end portion 11 and the opposed surface 12b of the second pipeline end portion 12 of the manifold 1 are respectively vertical planes, whereas the complementary surface 31a of the first flow path end portion 31 and the complementary surface 32a of the second flow path end portion 32 of the exchange unit 3 are also vertical planes. In such a case, when the exchange unit 3 is fixed to the manifold 1 while pressing the exchange unit 3 in the mounting direction with the pressing force F, the complementary surface 31a of the first flow path end portion 31 and the complementary surface 32a of the second flow path end portion 32 of the exchange unit 3 press the opposed surface 11b of the first pipeline end portion 11 and the opposed surface 12b of the first pipeline end portion 12 directly with the pressing force F.

### Third Embodiment

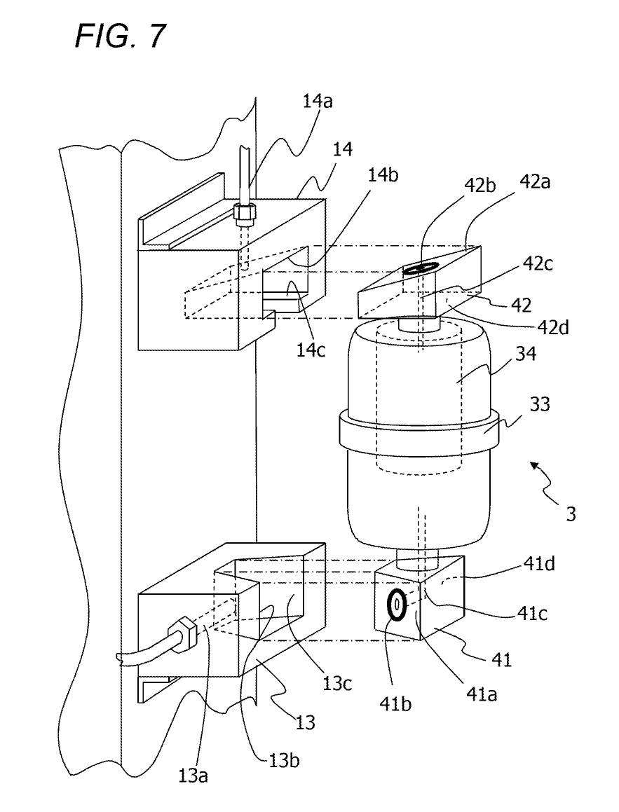

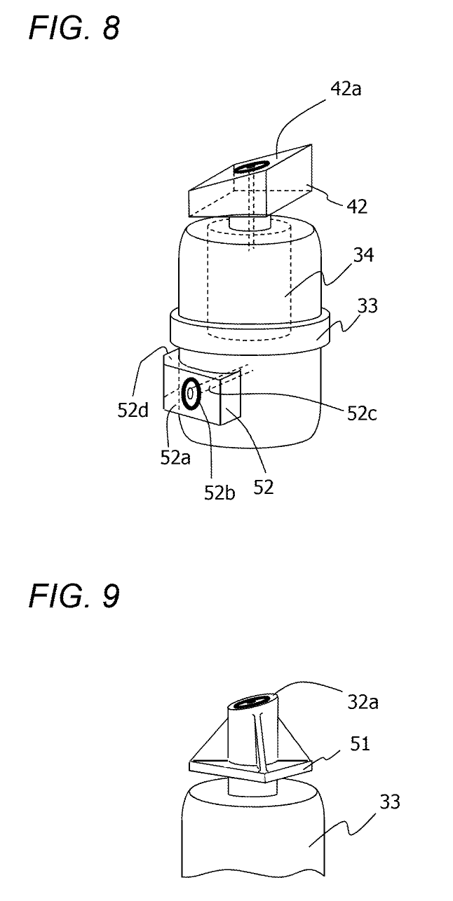

With reference to FIG. 7 and FIG. 8, a third embodiment of the present invention is described. FIG. 7 is a view for illustrating the exchange unit 3 according to the third embodiment. FIG. 8 is a view for illustrating a modification example of the exchange unit 3 according to the third embodiment. In the first embodiment, the positioning is performed along the axis extending in the direction from the first pipeline end portion 11 to the second pipeline end portion 12 of the manifold 1 by the joint between the complementary surface 31a of the first flow path end portion 31 of the exchange unit 3 and the opposed surface 11b of the first pipeline end portion 11 of the manifold 1 and the joint between the complementary surface 32a of the second flow path end portion 32 of the exchange unit 3 and the opposed surface 12b of the second pipeline end portion 12 of the manifold 1. In the third embodiment, however, the functions of the first embodiment are fulfilled only in a second flow path end portion 42 of the exchange unit 3 and a second pipeline end portion 14 of the manifold 1. In the third embodiment, the positioning is performed in the first flow path end portion 41 of the exchange unit 3 and the first pipeline end portion 13 of the manifold 1 along a direction perpendicular to a direction from a first pipeline end portion 13 to the second pipeline end portion 14 of the manifold 1.

A direction of inclination of an opposed surface 13b of the first pipeline end portion 13 of the manifold 1 and a direction of inclination of an opposed surface 14b of the second pipeline end portion 14 are shifted by 90 degrees from each other. Both of the opposed surfaces have such inclinations that are reduced in the mounting direction of the exchange unit 3. Further, for the first pipeline end portion 13 of the manifold 1, the first pipeline end portion 13 of the manifold 1 has an opposed surface 13c which is opposed to the opposed surface 13b of the first pipeline end portion 13. The opposed surface 13b and the opposed surface 13c have such inclinations that are reduced in the mounting direction of the exchange unit 3. For the second pipeline end portion 14 of the manifold 1, the second pipeline end portion 14 of the manifold 1 has an opposed surface 14c which is opposed to the opposed surface 14b of the second pipeline end portion 14. The opposed surface 14b and the opposed surface 14c have such inclinations that are reduced in the mounting direction of the exchange unit 3.

The same applies to the exchange unit 3. A direction of inclination of a complementary surface 41a of the second flow path end portion 41 of the exchange unit 3 and a direction of inclination of a complementary surface 42a of the second flow path end portion 42 are shifted by 90 degrees. Both of the complementary surfaces have such inclinations that are reduced in the mounting direction of the exchange unit 3. Further, for the first flow path end portion 41 of the exchange unit 3, the first flow path end portion 41 of the exchange unit 3 has a complementary surface 41d on a side opposite to the complementary surface 41a. The complementary surface 41a and the complementary surface 41d have such inclinations that are reduced in the mounting direction of the exchange unit 3. The second flow path end portion 42 of the manifold 1 has a complementary surface 42d on a side opposite to the complementary surface 42a. The complementary surface 41ab and the complementary surface 41d have such inclinations that are reduced in the mounting direction of the exchange unit 3. Specifically, the direction of inclination of the opposed surface 13b of the first pipeline end portion 13 and the direction of inclination of the opposed surface 14b of the second pipeline end portion 14 of the manifold 1 are set to be inclined in the directions about the same axis so that the opposed surface 13b and the opposed surface 14b are held in a tensed manner at both ends of the exchange unit 3 between the complementary surface 41a of the first flow path end portion 41 and the complementary surface 42a of the second flow path end portion 42 of the exchange unit 3.

In the third embodiment, positioning in one axial direction being a direction from the first pipeline end portion 13 to the second pipeline end portion 14 of the manifold 1 is performed not at both ends of the exchange unit 3 but at one end of the exchange unit 3. In this case, it is supposed that the manufacturing tolerance is kept with high accuracy only on one end portion side of the exchange unit 3, for example, only on the second flow path end portion 42 side. When the manufacturing tolerance is kept with high accuracy only on the second flow path end portion 42 side of the exchange unit 3, a distance between the complementary surface 42a and the complementary surface 42d in the second flow path end portion 42 of the exchange unit 3 is shorter than the distance between the first flow path end portion 41 and the second flow path end portion 42 in the case of the first embodiment. Therefore, a manufacturing variation becomes smaller in the third embodiment than in the case of the first embodiment. Thus, the exchange unit 3 can be supported only on one side thereof, for example, only on the second flow path end portion 2 side. Even in the case of the third embodiment, a total length tolerance is relatively small. Therefore, it is disadvantageous to set the directions of inclination about the same axis as in the first embodiment. Thus, in the third embodiment, the directions of inclination of the complementary surface 41a of the first flow path end portion 41 and the complementary surface 32a of the second flow path end portion 32 are set to the directions of inclinations about different axes.

As illustrated in FIG. 7, the opposed surface 14b is formed on an upper side of the second pipeline end portion 14 of the manifold 1, whereas the opposed surface 14c is formed on a side opposed thereto. The second pipeline end portion 32 of the exchange unit 3 has the complementary surface 42a so as to correspond to the opposed surface 14b on the upper side of the second pipeline end portion 14 of the manifold 1 and the complementary surface 42d so as to correspond to the opposed surface 14c. The opposed surface 42b and the opposed surface 42d are reduced in the mounting direction of the exchange unit 3. Correspondingly, the complementary surface 42a and the complementary surface 42c of the exchange unit 3 are reduced in the mounting direction of the exchange unit 3. With this arrangement, when the second flow path end portion 42 of the exchange unit 3 is inserted into the second pipeline end portion 14 of the manifold 1 in the mounting direction of the exchange unit 3 so that the complementary surface 42a of the exchange unit 3 presses the opposed surface 14b of the manifold 1 and the complementary surface 42c of the exchange unit 3 presses the opposed surface 14c of the manifold 1, the second pipeline end portion 14 of the manifold 1 and the second flow path end portion 42 of the exchange unit 3 can be joined while pressing a sealing member 42b with an appropriate pressure. At this time, as in the case of the first embodiment, it is suitable to provide the expanding portion 35 which has been described above in the first embodiment to any one of a pipeline of the second pipeline end portion 14 of the manifold 1 and a pipeline of the second flow path end portion 42 of the exchange unit 3 at a coupled portion.

The same applies to the first pipeline end portion 14 of the manifold 1 and the first flow path end portion 41 of the exchange unit 3. A direction of inclination of the complementary surface 41a of the second pipeline end portion 41 of the exchange unit 3 and a direction of inclination of the complementary surface 42a of the second flow path end portion 42 are shifted by 90 degrees. The first pipeline end portion 13 of the manifold 1 has the opposed surface 13b on an upper side and the opposed surface 13c on a side opposed thereto. The first flow path end portion 41 of the exchange unit 3 has the complementary surface 41a so as to correspond to the opposed surface 13b of the first pipeline end portion 13 of the manifold 1 and the complementary surface 41d so as to correspond to the opposed surface 13c. The opposed surface 13b and the opposed surface 13c are reduced in the mounting direction of the exchange unit 3. Correspondingly, the complementary surface 41a and the complementary surface 41c of the exchange unit 3 are also reduced in the mounting direction of the exchange unit 3. With this arrangement, when the first flow path end portion 41 of the exchange unit 3 is inserted into the first pipeline end portion 13 of the manifold 1 in the mounting direction of the exchange unit 3 so that the complementary surface 41a of the exchange unit 3 presses the opposed surface 13b of the manifold 1 and the complementary surface 41d of the exchange unit 3 presses the opposed surface 13c of the manifold 1, the first pipeline end portion 13 of the manifold 1 and the first flow path end portion 41 of the exchange unit 3 can be joined while pressing a sealing member 41b with an appropriate pressure. Even in this case, as in the case of the first embodiment, it is suitable to provide the expanding portion 35 which has been described in the first embodiment to any one of the pipeline of the first pipeline end portion 13 of the manifold 1 and the pipeline of the first flow path end portion 41 of the exchange unit 3 at the coupled portion.

Specifically, in the third embodiment, the first pipeline end portion 13 of the manifold 1 has the opposed surface 13b being a first opposed surface and the opposed surface 13c being a second opposed surface opposed thereto, whereas the first flow path end portion 41 of the exchange unit 3 at the corresponding position has the complementary surface 41a being a first complementary surface and the complementary surface 41d being a second complementary surface positioned on the opposite side thereto. Meanwhile, the second pipeline end portion 14 has the opposed surface 14b being a third opposed surface and the opposed surface 14c being a fourth opposed surface opposed thereto, whereas the second flow path end portion 42 of the exchange unit 3 at the corresponding position has the complementary surface 41a being a third complementary surface and the complementary surface 41d being a fourth complementary surface positioned on the opposite side thereto.

Although the first flow path end portion 31 and the second flow path end portion 32 of the exchange unit 3 have been described as the block-like members extending from the main body portion 33, a complementary surface 51a may be directly mounted to the main body portion 33, similarly to a first flow path end portion 52 of the exchange unit 3 illustrated in FIG. 8. Even in this case, a relationship between the complementary surface 52a and a complementary surface 52d is the same. Further, a relationship between the complementary surface 52a and the opposed surface 13b opposed thereto and a relationship between the complementary surface 52a and the opposed surface 13b opposed thereto are the same.

In the first embodiment to the third embodiment, the first flow path end portion 31, the second flow path end portion 32, the first flow path end portion 41, and the first flow path end portion 42 of the exchange unit 3 have the block-like shapes. An advantage of the shape lies in that, for example, in the case of the first embodiment, the inclined surfaces are used for the opposed surface 11b of the first pipeline end portion 11 and the opposed surface 12b of the second pipeline end portion 12 of the manifold 1 and the complementary surface 31a of the second flow path end portion 31 and the complementary surface 32a of the second flow path end portion 32 of the exchange unit 3 to enable elimination of a difference in position between the complementary surface 31a of the second flow path end portion 31 and the complementary surface 32a of the second flow path end portion 32 of the exchange unit 3, which is generated due to a manufacturing dimensional tolerance. This is an advantageous effect in adjustment of the pressing force and the positions of the pipelines as described above. Further, there is an aspect of providing an advantageous effect that lateral surfaces of the complementary surface 31a and lateral surfaces of the complementary surface 32a guide the complementary surface 31a of the second flow path end portion 31 and the complementary surface 32a of the second flow path end portion 32 of the exchange unit 3 in a correct direction of inclination. For example, theoretically, the complementary surface 31a and the complementary surface 32a only need to have inclinations only at portions corresponding to the pipelines. For example, a mode illustrated in FIG. 9 can be employed. In this manner, specifically, only a portion of the complementary surface 31a of the first flow path end portion 31 or a portion of the complementary surface 32a of the second flow path end portion 32, which corresponds to the pipe, is made to have a complementary shape corresponding to the opposed surface 11b of the first pipeline end portion 11 or the opposed surface 12b of the second pipeline end portion 12 of the manifold 1. In this case, because of a small area of the inclined surface, a rib 51 can be provided so as to provide an effect of the side surfaces of the block shape of the second flow path end portion 32 of the exchange unit 3.

### REFERENCE SIGNS LIST

1 manifold
3 exchange unit
11 first pipeline end portion
11b opposed surface
12 second pipeline end portion
12b opposed surface
31 first flow path end portion
32 second flow path end portion
33 main body portion
34 filter

1. An exchange unit to be removably mounted in a predetermined mounting direction between a first pipeline end portion and a second pipeline end portion of a manifold of a flow circuit, the manifold comprising the first pipeline end portion having a first opposed surface reduced in the predetermined mounting direction, and the second pipeline end portion having a second opposed surface reduced in the predetermined mounting direction, the exchange unit comprising:
a main body portion;
a first flow path end portion provided on one end side of the main body portion, which includes a pipeline configured to communicate with a flow path inside the main body portion through a fluid and has a first complementary surface having a shape complementary to the first opposed surface;
a second flow path end portion provided on an opposite side of the main body portion to the side on which the first flow path end portion is provided, which includes a pipeline configured to communicate with an inside of the main body portion through the fluid and has a second complementary surface having a shape complementary to the second opposed surface;
a sealing member provided to any one of the first opposed surface and the first complementary surface to be brought into close contact with the first opposed surface and the first complementary surface; and
a sealing member provided to any one of the second opposed surface and the second complementary surface to be brought into close contact with the first opposed surface and the first complementary surface,
wherein, when the first flow path end portion of the exchange unit is mounted to the first pipeline end portion of the manifold and the second pipeline end portion of the exchange unit is mounted to the second pipeline end portion of the manifold, the flow circuit is formed.

2. An exchange unit according to claim 1, wherein any one of a pipeline of the flow circuit in the first pipeline end portion and the pipeline in the first flow path end portion has an expanding portion, and
wherein any one of a pipeline of the flow circuit in the second pipeline end portion and the pipeline in the second flow path end portion has an expanding portion.

3. An exchange unit according to claim 1, wherein the first opposed surface and the first complementary surface have the same angle of inclination, whereas the second opposed surface and the second complementary surface have the same angle of inclination.

4. A flow circuit system, comprising:
an exchange unit to be removably mounted in a predetermined mounting direction between a first pipeline end portion and a second pipeline end portion of a manifold of a flow circuit, the manifold comprising the first pipeline end portion having a first opposed surface reduced in the predetermined mounting direction, and the second pipeline end portion having a second opposed surface reduced in the predetermined mounting direction,
the exchange unit comprising:
a main body portion;
a first flow path end portion provided on one end side of the main body portion, which includes a pipeline configured to communicate with a flow path inside the main body portion through a fluid and has a first complementary surface having a shape complementary to the first opposed surface;
a second flow path end portion provided on an opposite side of the main body portion to the side on which the first flow path end portion is provided, which includes a pipeline configured to communicate with an inside of the main body portion through the fluid and has a second complementary surface having a shape complementary to the second opposed surface;
a sealing member provided to any one of the first opposed surface and the first complementary surface to be brought into close contact with the first opposed surface and the first complementary surface; and
a sealing member provided to any one of the second opposed surface and the second complementary surface to be brought into close contact with the first opposed surface and the first complementary surface,
wherein, when the first flow path end portion of the exchange unit is mounted to the first pipeline end portion of the manifold and the second pipeline end portion of the exchange unit is mounted to the second pipeline end portion of the manifold, the flow circuit is formed.

5. A flow circuit system according to claim 4,
wherein any one of a pipeline of the flow circuit in the first pipeline end portion and the pipeline in the first flow path end portion has an expanding portion, and
wherein any one of a pipeline of the flow circuit in the second pipeline end portion and the pipeline in the second flow path end portion has an expanding portion.

6. A flow circuit system according to claim 4, wherein the first opposed surface and the first complementary surface have the same angle of inclination, whereas the second opposed surface and the second complementary surface have the same angle of inclination.

7. An exchange unit to be removably mounted in a predetermined mounting direction between a first pipeline end portion and a second pipeline end portion of a manifold of a flow circuit, the manifold comprising the first pipeline end portion having a first opposed surface and a second opposed surface reduced in the predetermined mounting direction, and the second pipeline end portion having a third opposed surface and a fourth opposed surface reduced in the predetermined mounting direction,
the exchange unit comprising:
a main body portion;
a first flow path end portion provided on one end side of the main body portion, which includes a pipeline configured to communicate with an inside of the main body portion through a fluid and has a first complementary surface having a shape complementary to the first opposed surface and a second complementary surface having a shape complementary to the second opposed surface; and
a second flow path end portion provided on an opposite side of the main body portion to the side on which the first flow path end portion is provided, which includes a pipeline configured to communicate with a flow path inside the main body portion through the fluid and has a third complementary surface having a shape complementary to the third opposed surface and a fourth complementary surface having a shape complementary to the fourth opposed surface,
wherein, when the first flow path end portion of the exchange unit is mounted to the first pipeline end portion of the manifold and the second pipeline end portion of the exchange unit is mounted to the second pipeline end portion of the manifold, the flow circuit is formed.

8. An exchange unit according to claim 7, wherein any one of a pipeline of the flow circuit in the first pipeline end portion and the pipeline in the first flow path end portion has an expanding portion; and
wherein any one of a pipeline of the flow circuit in the second pipeline end portion and the pipeline in the second flow path end portion has an expanding portion.

9. An exchange unit according to claim 7,
wherein the first opposed surface and the first complementary surface have the same angle of inclination,
wherein the second opposed surface and the second complementary surface have the same angle of inclination,
wherein the third opposed surface and the third complementary surface have the same angle of inclination, and
wherein the fourth opposed surface and the fourth complementary surface have the same angle of inclination.

10. A flow circuit system, comprising:
an exchange unit to be removably mounted in a predetermined mounting direction between a first pipeline end portion and a second pipeline end portion of a manifold of a flow circuit, the manifold comprising the first pipeline end portion having a first opposed surface and a second opposed surface reduced in the predetermined mounting direction, and the second pipeline end portion having a third opposed surface and a fourth opposed surface reduced in the predetermined mounting direction,
the exchange unit comprising:
a main body portion;
a first flow path end portion provided on one end side of the main body portion, which includes a pipeline configured to communicate with an inside of the main body portion through a fluid and has a first complementary surface having a shape complementary to the first opposed surface and a second complementary surface having a shape complementary to the second opposed surface; and
a second flow path end portion provided on an opposite side of the main body portion to the side on which the first flow path end portion is provided, which includes a pipeline configured to communicate with a flow path inside the main body portion through the fluid and has a third complementary surface having a shape complementary to the third opposed surface and a fourth complementary surface having a shape complementary to the fourth opposed surface,
wherein, when the first flow path end portion of the exchange unit is mounted to the first pipeline end portion of the manifold and the second pipeline end portion of the exchange unit is mounted to the second pipeline end portion of the manifold, the flow circuit is formed.

11. A flow circuit system according to claim 10,
wherein any one of a pipeline of the flow circuit in the first pipeline end portion and the pipeline in the first flow path end portion has an expanding portion; and
wherein any one of a pipeline of the flow circuit in the second pipeline end portion and the pipeline in the second flow path end portion has an expanding portion.

12. A flow circuit system according to claim 10,
wherein the first opposed surface and the first complementary surface have the same angle of inclination,
wherein the second opposed surface and the second complementary surface have the same angle of inclination,
wherein the third opposed surface and the third complementary surface have the same angle of inclination, and
wherein the fourth opposed surface and the fourth complementary surface have the same angle of inclination.
